(19) United States
(12) Patent Application Publication
(10) Pub. No.: US 2003/0218967 A1
(43) Pub. Date: Nov. 27, 2003

(54) Abrasion-resistant compact disc

(75) Inventors: Chia-Wen Hsu, Taipei (TW); Li-Chuan Chiu, Taoyuan (TW); Ching-Kuan Lee, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: Daxon Technology Inc.

(21) Appl. No.: 10/436,755

(22) Filed: May 12, 2003

(30) Foreign Application Priority Data
May 27, 2002 (TW) 91207693

(51) Int. Cl. G11B 3/70; G11B 5/84; G11B 7/26

(52) U.S. Cl. 369/280

(57) ABSTRACT

An abrasion-resistant disc. The disc has a plurality of protrusions at the edge of the bottom surface. The protrusions prevent abrasion to the bottom surface of the disc.

### BACKGROUND OF THE INVENTION

1. Field of the Invention

The present invention relates to a compact disc, and in particular to a compact disc able to resist abrasion.

2. Description of the Related Art

Compact discs (CDs) or digital video discs (DVDs) are popular optical storage devices used to store multimedia data or backup files.

FIG. 1A is a schematic top view of a conventional CD, and FIG. 1B is a cross section of line a-a. In FIGS. 1A and 1B, the conventional CD is a plastic disc 10 made by injection molding. The disc 10 has a central hole 11, a top surface and a read/write surface 13, which the laser bean passes through. The top surface of the disc 10 is provided for coating, gluing, and printing. The disc 10 has a recording area 131 between the central hole 11 and the outer edge of the disc 10. There is an annular data-recording layer 14 disposed within the recording area 131. The disc 10 also has a ring protrusion 12 disposed on the read/write surface around the central hole 11 with an interval. In FIG. 2B, it is next to the recording area 131.

The ring protrusion 12 has a thickness of about 1-2 mm to prevent vacuum adherence. The ring protrusion 12 of the disc 10 contacts the top surface of the next disc when discs are stacked together. The surface close to the ring protrusion 12 of the disc does not contact the top surface of the next, however, if the portion near the outer edge is deformed because of gravity and plastic deformation and contacts the top surface of the next. As well, when a disc is placed on a surface, the portion near the easily deformed outer edge contacts the surface. The bottom surface of the disc is easily damaged, becoming unreadable.

Hence, there is a need for a dependable compact disc to resist abrasion and thus protect data.

### SUMMARY OF THE INVENTION

Accordingly, an object of the invention is to provide an abrasion-resistant compact disc. The compact disc's bottom surface is protected from abrasion.

The present invention provides an abrasion-resistant compact disc. The compact disc has a central hole and a read/write surface. The compact disc also has a plurality of protrusions disposed on the outer edge of the read/write surface.

According to the preferred embodiment, the compact disc is made by injection molding. The protrusions are circular and symmetrically disposed at the outer edge.

Moreover, the abrasion-resistant compact disc further includes a recording area disposed within the area between the central hole and the outer edge of the compact disc. The abrasion-resistant compact disc of the invention is a CD-ROM, CD-R, CD-RW, DVD-ROM, DVD-R, or DVD-RW.

A detailed description is given in the following embodiments with reference to the accompanying drawings.

### BRIEF DESCRIPTION OF THE DRAWINGS

The present invention is more fully understood by reading the subsequent detailed description and examples with references made to the accompanying drawings, wherein:

FIG. 1A is a schematic top view of a conventional compact disc;

FIG. 1B is a cross section of line a-a in FIG. 1A;

FIG. 2A is a schematic top view of the compact disc of the invention; and

FIG. 2B is a cross section of line b-b in FIG. 2A.

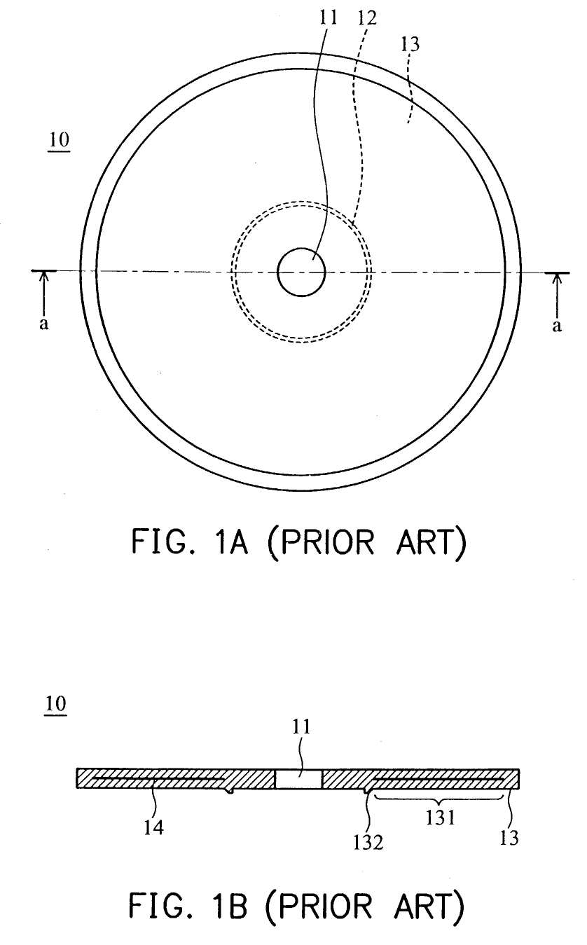

### DETAILED DESCRIPTION OF THE INVENTION

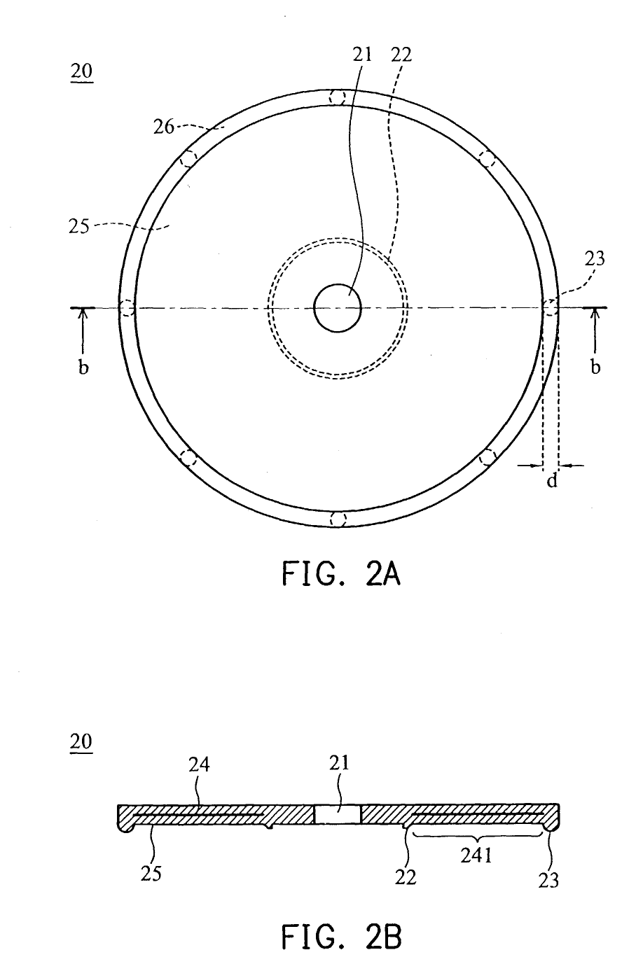

FIGS. 2A and 2B show the compact disc 20, made by injection molding, made of engineering plastic, such as Acrylic, PolyCarbonate (PC) or ABS plastic. The disc 20 has a central hole 21 and a read/write surface 25. The central hole 21 is for the drive shaft. The read/write surface 25 includes a recording area 241 with an annular data-recording layer 24 disposed therein. The data recorded on the data-recording layer 24 is read by a laser beam emitted from the pick head of the drive.

Furthermore, the disc 20 also has a ring protrusion 22 disposed on the read/write surface 25 around the central hole 21 at predetermined intervals. The recording area 241 is next to the ring protrusion 22. The data-recording layer 24 is disposed in the recording area 241 between the ring protrusion 22 and the outer edge of the disc 20. In FIGS. 2A and 2B, there is a ring area 26 with predetermined interval “d” formed between the outer edge of the data-recording area 241 and the outer edge of the disc 10. The interval d is about 1˜2 mm. In order to protect the read/write surface 25 of the disc 20, the disc 20 of the invention has a plurality of protrusions 23 disposed symmetrically within this ring area 26 on the read/write surface 25, and are circular with a diameter less than 2 mm and thickness of about 0.1˜0.2 mm.

Accordingly, the edge portion of the disc 20 cannot be deformed, because of the protrusions 23. The protrusions 23 protect the read/write surface 25 near the edge portion from contacting the top surface of another disc when discs are stacked together. As well, the protrusions 23 protect the read/write surface 25 near the edge portion when it placed on a surface. Thus, the disc 20 prevents data loss caused by damage to the recording area 241.

In the embodiment of the invention, the protrusions 23 can be in other shapes, such as triangles or squares, and can be replaced by another ring protrusion within the ring area 26 with a thickness of 0.1˜0.2 mm.

The abrasion-resistant compact disc with protrusions disposed around the outer edge is a CD-ROM, CD-R, or CD-RW. In addition, the invention is suitable for DVD discs bonding two similar substrates, such that the bottom substrate of the DVD disc has a plurality of protrusions symmetrically disposed on the bottom surface and around the edge portion. Thus, the abrasion-resistant disc is a DVD-ROM, DVD-R, or DVD-RW.

In order to test the abrasion-resistant ability of the disc, conventional discs and the discs of the invention were placed on sandpaper (No.200) and rubbed for 3 minutes. They were checked in a CD-ROM drive. The results are shown below:

| | | | | Loss |
|---|---|---|---|---|
| | Total | Unreadable | readable | Ratio |
| Conventional CD | 20 | 15 | 5 | 75% |
| CD with | 20 | 3 | 17 | 6% |
| protrusions | | | | |

According to the table above, the conventional discs were damaged, such that 75% of the total could not be read by a CD-ROM drive. In contrast, the discs with protrusions of the invention showed a considerably reduced loss ratio, the inventive protrusions clearly protecting the discs from undue damaged.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An abrasion-resistant compact disc, comprising:
a disc body, having a central hole and a read/write surface; and
a plurality of protrusions, disposed on the read/write surface and at the outer edge of the disc body.

2. The abrasion-resistant compact disc as claimed in claim 1, wherein the protrusions are symmetrically disposed at the edge of the read/write surface.

3. The abrasion-resistant compact disc as claimed in claim 1, wherein the disc body is made by injection molding.

4. The abrasion-resistant compact disc as claimed in claim 1, wherein the protrusions are circular.

5. The abrasion-resistant compact disc as claimed in claim 1, further comprising:
a recording area, disposed in the area between the central hole and the outer edge of the disc body to record digital data.

6. The abrasion-resistant compact disc as claimed in claim 1, wherein the compact disc is a CD-ROM, a CD-R, or a CD-RW.

7. The abrasion-resistant compact disc as claimed in claim 1, wherein the compact disc is a DVD-ROM, a DVD-R, or a DVD-RW.
